(19) United States
(12) Patent Application Publication
(10) Pub. No.: US 2026/0254147 A1
(43) Pub. Date: Aug. 27, 2026

(54) CONNECTOR

(71) Applicant: YAZAKI CORPORATION, Tokyo (JP)

(72) Inventors: Yuta Kusuda, Kakegawa-shi (JP); Takao Murakami, Kakegawa-shi (JP); Masanori Nakamura, Kakegawa-shi (JP)

(21) Appl. No.: 19/538,991

(22) Filed: Feb. 13, 2026

(30) Foreign Application Priority Data
Feb. 26, 2025 (JP) 2025-029308

(51) Int. Cl. H01R 13/506; H01R 13/514; H01R 13/52; H01R 13/629

(52) U.S. Cl. CPC H01R 13/506; H01R 13/514; H01R 13/5202; H01R 13/629

(57) ABSTRACT

A connector includes a first terminal configured to connect to a counterpart terminal; a housing configured to accommodate the first terminal; and a terminal-equipped electric wire including: a second terminal configured to be fastened to a predetermined portion inside the housing and electrically connected to the first terminal; an electric wire extending from the second terminal; and an engaging portion engaged with the housing. A position of the second terminal in a circumferential direction of a fastening axis of the second terminal is adjustable by adjusting an engaging position between the engaging portion and the housing. The housing includes an opening portion having an opening width through which the terminal-equipped electric wire is insertable into and out of the housing regardless of the position of the second terminal in the circumferential direction.

### CROSS-REFERENCE TO RELATED APPLICATIONS

This application is based on and claims priority under 35 USC 119 from Japanese Patent Application No. 2025-029308 filed on February 26, 2025, the entire content of which is incorporated herein by reference.

### TECHNICAL FIELD

The present disclosure relates to a connector including: a first terminal to which a counterpart terminal is to be connected; a housing in which the first terminal is accommodated; and a terminal-equipped electric wire, which includes a second terminal fastened at a predetermined portion inside the housing and electrically connected to the first terminal, and an electric wire extending from the second terminal.

### BACKGROUND ART

Various connectors have been proposed for use in a cable mounted on a vehicle or the like as disclosed in, for example, JP2022-083460A.

In the connector of the above type, when the electric wire extending from the connector is different in its wiring direction depending on a specification of the vehicle or the like, generally, the connector is manufactured using a desired housing selected from a plurality of types of housings having different shapes depending on the specifications. However, the production efficiency of the connector may be hindered if the plurality of types of housings are manufactured and stored in advance to be selected depending on the specifications. For this reason, a connector capable of coping with various wiring directions while using a common housing has been desired.

An object of the present disclosure is to provide a connector capable of coping with various wiring directions while using a common housing.

In order to achieve the above object, a connector according to the present disclosure is characterized by the following.

### SUMMARY

A connector includes a first terminal configured to connect to a counterpart terminal; a housing configured to accommodate the first terminal; and a terminal-equipped electric wire including: a second terminal configured to be fastened to a predetermined portion inside the housing and electrically connected to the first terminal; an electric wire extending from the second terminal; and an engaging portion engaged with the housing. A position of the second terminal in a circumferential direction of a fastening axis of the second terminal is adjustable by adjusting an engaging position between the engaging portion and the housing. The housing includes an opening portion having an opening width through which the terminal-equipped electric wire is insertable into and out of the housing regardless of the position of the second terminal in the circumferential direction.

According to the connector of the present disclosure, the terminal-equipped electric wire includes the engaging portion that engages with the housing, and the position of the second terminal in the circumferential direction of the fastening axis of the second terminal can be adjusted by adjusting the engaging position between the engaging portion and the housing. Further, the opening portion of the housing has an opening width through which the terminal-equipped electric wire can be inserted into and out of the housing regardless of the position of the second terminal. Accordingly, when the position of the second terminal in the circumferential direction of the fastening axis is adjusted according to the wiring direction of the electric wire, the electric wire can be extended from the housing to cope with the wiring direction. Accordingly, the connector of the present disclosure can cope with various wiring directions while using a common housing.

The present disclosure has been briefly described above. Further, details of the present disclosure will be further clarified by reading modes for carrying out the disclosure described below with reference to the accompanying drawings.

### BRIEF DESCRIPTION OF DRAWINGS

FIG. 1 is a perspective view of a connector according to an embodiment of the present disclosure;

FIG. 2 is an exploded perspective view of the connector illustrated in FIG. 1;

FIG. 3 is a cross-sectional view taken along a line A-A in FIG. 1;

FIG. 4 is a perspective view of FIG. 3 viewed from the rear in a B-B cross section;

FIG. 5 is a perspective view corresponding to FIG. 4 with a terminal-equipped electric wire, a bolt, and a bellows boot omitted from the illustration;

FIG. 6 is a perspective view of a periphery of a terminal of the terminal-equipped electric wire forming the connector illustrated in FIG. 1 as viewed from the front;

FIG. 7 is a cross-sectional view taken along a line C-C in FIG. 4; and

FIG. 8 is a rear view illustrating that an extending direction of the terminal-equipped electric wire from a fastening axis of the terminal can be selected by selecting an engaging groove, to which a protruding strip portion of the terminal of the terminal-equipped electric wire is engaged, from among a plurality of engaging grooves formed in a housing.

### DESCRIPTION OF EMBODIMENTS

### Embodiments

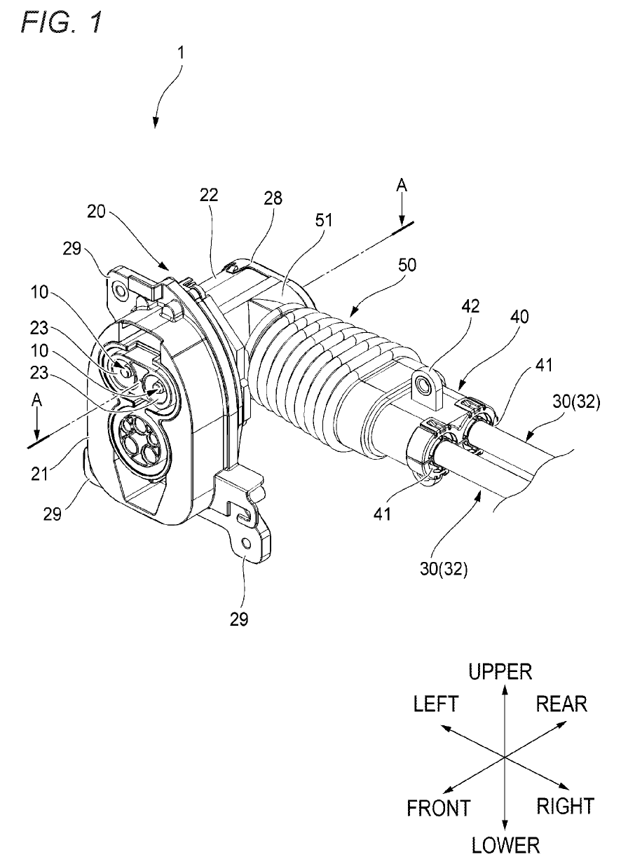

Hereinafter, a connector 1 according to an embodiment of the present disclosure will be described with reference to the drawings. The connector 1 illustrated in FIG. 1 functions as a relay connector that electrically connects a pair of terminal-equipped electric wires 30 extending from a tubular portion 22 of a housing 20 and a counterpart connector (not illustrated) fitted to a body portion 21 of the housing 20.

Hereinafter, for convenience of description, "front", "rear", "upper", "lower", "left", "right", a "front-rear direction", an "upper-lower direction", and a "left-right direction" are defined as illustrated in FIG. 1 or the like. The "front-rear direction", the "upper-lower direction", and the "left-right direction" are orthogonal to one another. The front-rear direction coincides with a fitting direction of the body portion 21 of the housing 20 and the counterpart connector. The left-right direction coincides with an extending direction of the pair of terminal-equipped electric wires 30 from the tubular portion 22. The front-rear direction, the left-right direction, and the upper-lower direction do not necessarily coincide with a front-rear direction, a left-right direction, and an upper-lower direction of a vehicle or the like when the connector 1 is mounted on the vehicle or the like.

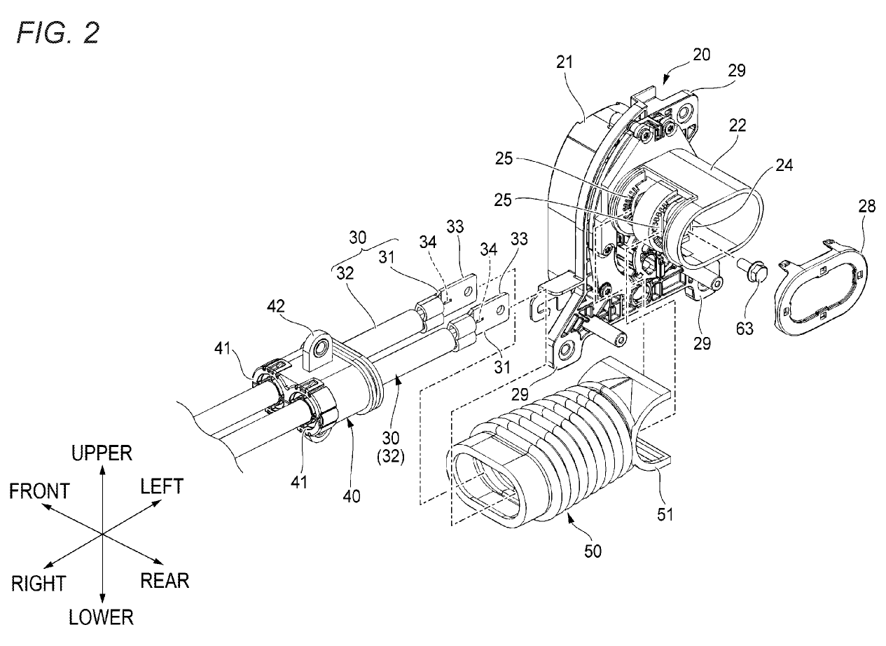

As illustrated in FIGS. 1 and 2, the connector 1 mainly includes a terminal (male terminal) 10 to which a counterpart terminal (female terminal, not illustrated) accommodated in the counterpart connector is to be connected, the housing 20 in which the terminal 10 is accommodated, and the terminal-equipped electric wire 30 that is fastened to a predetermined portion inside the housing 20 and is electrically connected to the terminal 10. Hereinafter, a configuration of each member forming the connector 1 will be described in order.

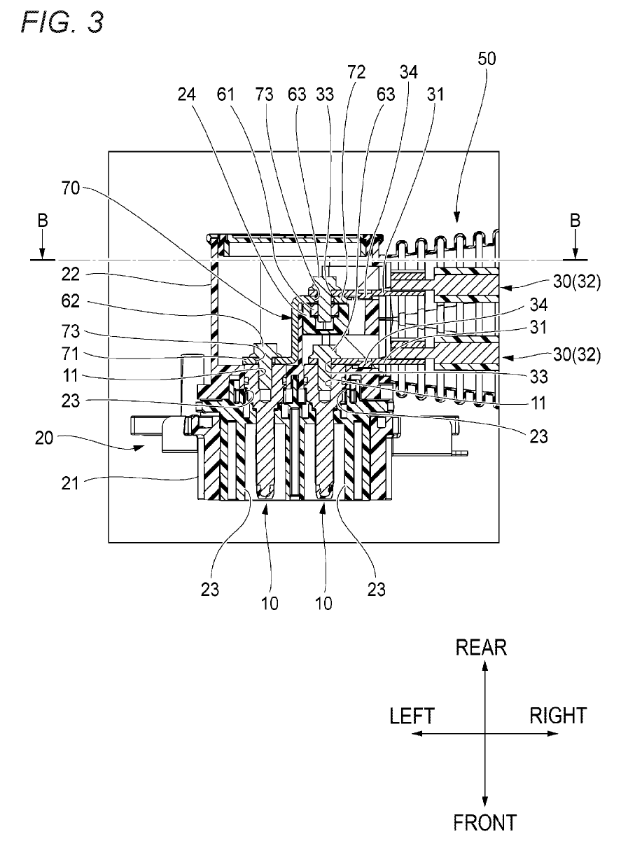

First, the terminal 10 will be described. As illustrated in FIGS. 1 and 3, the metal terminal 10 has a rod shape extending in the front-rear direction as a whole. A tip end portion (front end portion) of the terminal 10 is a portion to be connected to the counterpart terminal on the counterpart connector side when the connector 1 and the counterpart connector are fitted. A female screw hole 11 recessed forward is formed in a base end surface (rear end surface) of the terminal 10 (see FIG. 3).

Next, the housing 20 will be described. The housing 20 is a resin molded product, and as illustrated in FIGS. 1 and 2, includes the body portion 21 having a substantially rectangular flat plate shape extending in the upper-lower direction and the left-right direction and being long in the upper-lower direction, and the tubular portion 22 extending rearward from an upper region of the body portion 21. The housing 20 has a substantially L shape when viewed from the left-right direction. As illustrated in FIG. 2, the tubular portion 22 is a tubular part having an elongated hole shape elongated in the left-right direction when viewed from the rear and extending in the front-rear direction. In this example, the housing 20 (= the body portion 21 + the tubular portion 22) is implemented by combining a plurality of components as can be understood from FIG. 3, and may be implemented by a single component.

As illustrated in FIG. 3, a pair of left and right terminal accommodation holes 23 are provided in the upper region of the body portion 21 to penetrate in the front-rear direction and to be arranged at intervals in the left-right direction (see FIG. 1). A rear end opening of each terminal accommodation hole 23 communicates with an internal space of the tubular portion 22. A pair of left and right terminals 10 are inserted and accommodated into the pair of left and right terminal accommodation holes 23 from the rear side. A front end portion of the body portion 21 has a shape that can be fitted to the counterpart connector. When the connector 1 and the counterpart connector are fitted to each other, the tip end portion of the terminal 10 accommodated in the terminal accommodation hole 23 is connected to the counterpart terminal on the counterpart connector side.

As illustrated in FIG. 3, in the internal space of the tubular portion 22, a nut accommodation portion 24, in which a metal nut 61 is accommodated, is provided integrally with the tubular portion 22 at a position aligned with the terminal 10 at an interval in the front-rear direction on the rear side of the terminal 10 accommodated in the terminal accommodation hole 23 on the right side.

As illustrated in FIG. 3, in the internal space of the tubular portion 22, a strip-shaped metal plate member 70 extending while being bent in a crank shape is provided to straddle the base end surface of the terminal 10 accommodated in the terminal accommodation hole 23 on the left side and a seat surface (rear end surface) of the nut 61 accommodated in the nut accommodation portion 24. A bolt insertion hole 73 is formed in each of one end portion 71 and the other end portion 72 of the plate member 70. The bolt 62 inserted into the bolt insertion hole 73 of the one end portion 71 of the plate member 70 is screwed into the female screw hole 11 of the terminal 10 accommodated in the terminal accommodation hole 23 on the left side, so that the plate member 70 is fastened and fixed to

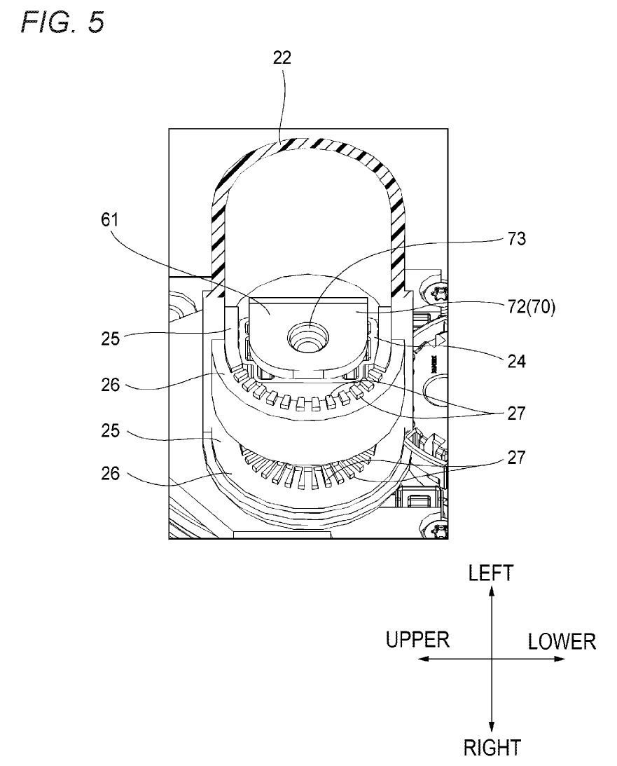

the terminal 10 such that the one end portion 71 overlaps the base end surface of the terminal 10, the other end portion 72 overlaps the seat surface of the nut 61, and the terminal 10 and the nut 61 are electrically connected to each other. The bolt insertion hole 73 of the other end portion 72 of the plate member 70 overlaps the female screw hole of the nut 61 (see FIG. 5).

As illustrated in FIG. 3, a bolt 63 for fastening and fixing a terminal 31 of the terminal-equipped electric wire 30 on the front side of the pair of front and rear terminal-equipped electric wires 30 is screwed into the female screw hole 11 of the terminal 10 accommodated in the terminal accommodation hole 23 on the right side. The bolt 63 for fastening and fixing the terminal 31 of the terminal-equipped electric wire 30 on the rear side of the pair of front and rear terminal-equipped electric wires 30 is screwed into the female screw hole of the nut 61 accommodated in the nut accommodation portion 24.

As illustrated in FIG. 2, on a right side surface of the tubular portion 22, a pair of front and rear opening portions 25 are arranged at intervals in the front-rear direction corresponding to the base end surface of the terminal 10 accommodated in the terminal accommodation hole 23 on the right side and the other end portion 72 of the plate member 70 overlapping the seat surface of the nut 61 accommodated in the nut accommodation portion 24. Each opening portion 25 extends in a circumferential direction of the tubular portion 22 and in the front-rear direction in a semicircular arc shape protruding rightward, and has a curved opening shape protruding rightward. The base end surface of the terminal 10 accommodated in the terminal accommodation hole 23 on the right side is exposed to the outside of the tubular portion 22 through the opening portion 25 on the front side. On the other hand, the other end portion 72 of the plate member 70 overlapping the seat surface of the nut 61 is exposed to the outside of the tubular portion 22 through the opening portion 25 on the rear side.

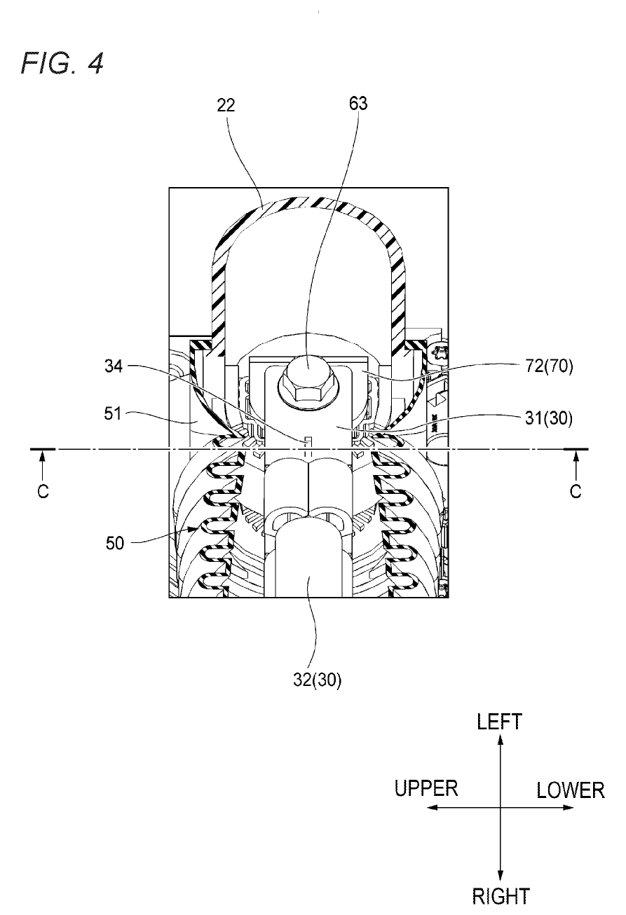

As illustrated in FIGS. 4 and 5, in each of the pair of front and rear opening portions 25, an opening edge on the rear side protruding rightward and extending in a semicircular arc shape is provided with a seat surface 26 protruding rightward along the opening edge and extending in the semicircular arc shape. Each seat surface 26 is a flat surface facing rearward (extending in a direction orthogonal to the front-rear direction). In the front-rear direction, a position of the seat surface 26 of the opening portion 25 on the front side substantially coincides with a position of the base end surface of the terminal 10 accommodated in the terminal accommodation hole 23 on the right side, and a position of the seat surface 26 of the opening portion 25 on the rear side substantially coincides with a position of a surface (rear end surface) on a side opposite to the nut 61 of the other end portion 72 of the plate member 70 overlapping the seat surface of the nut 61.

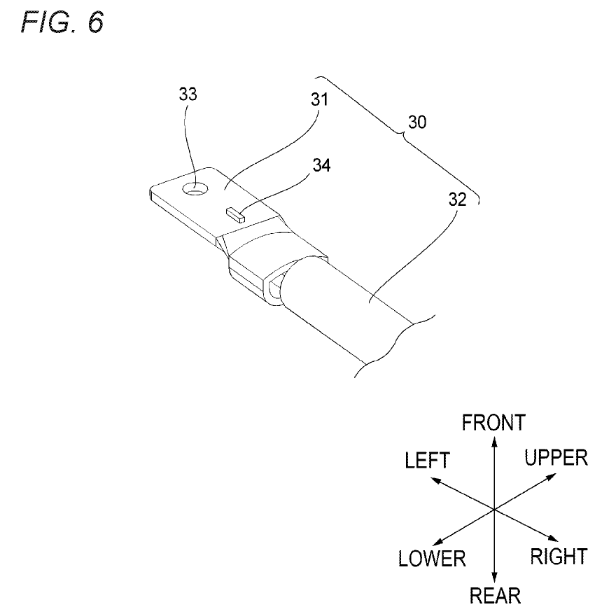

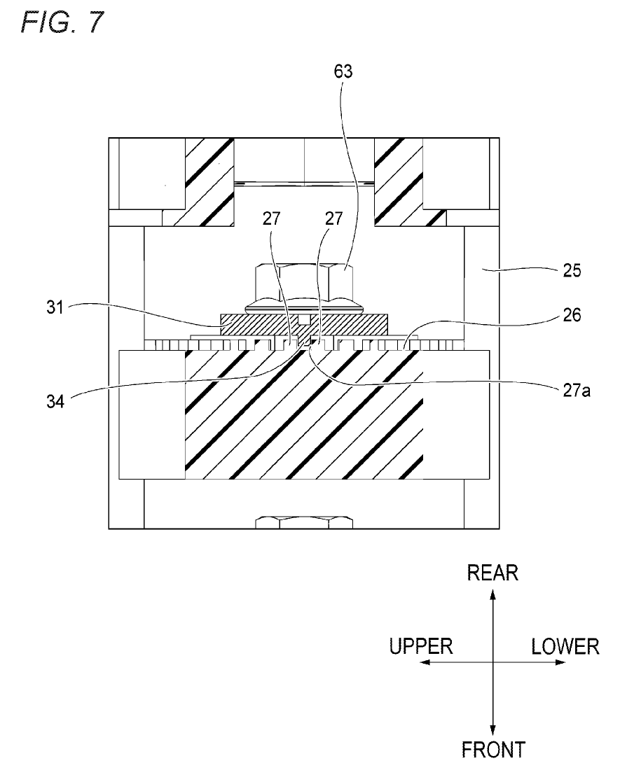

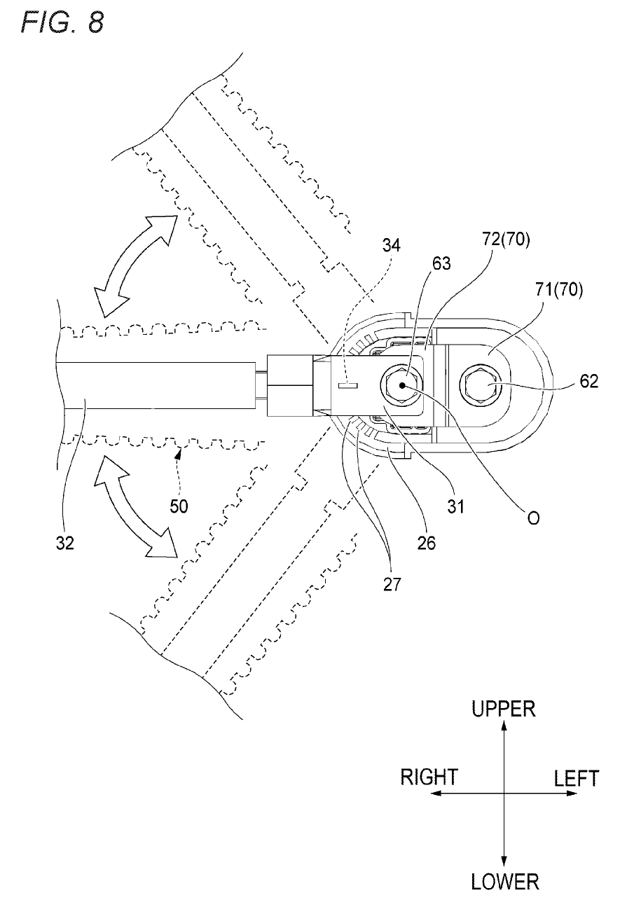

As illustrated in FIG. 5, each of the pair of front and rear seat surfaces 26 is provided with a plurality of protruding strip portions 27 arranged at predetermined intervals in an arc shape protruding rightward along the seat surface 26 extending in a semicircular arc shape protruding rightward. Each protruding strip portion 27 is a protruding strip protruding rearward from the seat surface 26 and extending in a direction along a straight line passing through a fastening axis O (see FIG. 8) of the terminal 31 (the bolt 63 for fastening the terminal 31) of the corresponding terminal-equipped electric wire 30. An engaging groove 27a is formed between adjacent pair of the protruding strip portions 27 (see FIG. 7). A protruding strip portion 34 (see FIG. 6) described later of the terminal 31 of the terminal-equipped electric wire 30 engages with one engaging groove 27a selected from a plurality of the engaging grooves 27a (see FIG. 7).

Next, the terminal-equipped electric wire 30 will be described. As illustrated in FIGS. 2 and 6, the terminal-equipped electric wire 30 includes the metal terminal 31 and an electric wire 32 extending from the terminal 31. A bolt insertion hole 33 and the protruding strip portion 34 located on the base end side (electric wire 32 side) of the terminal 31 with respect to the bolt insertion hole 33 are provided in a flat plate-shaped tip end portion of the terminal 31. The protruding strip portion 34 is a protruding strip protruding from one side surface (front side surface) of the tip end portion of the terminal 31 and extending along a longitudinal direction of the terminal 31 (extending direction of the electric wire 32 extending from the terminal 31). The electric wire 32 includes a conductor core wire and an insulating sheath covering an outer periphery of the conductor core wire, and an end portion of the conductor core wire is conductively connected to the terminal 31. The electric wire 32 is flexibly bendable.

As illustrated in FIGS. 1 and 2, a holder 40 and a bellows boot 50 are inserted into the pair of front and rear terminal-equipped electric wires 30 in this order from the tip end side (terminal 31 side) of the electric wire 32. The holder 40 made of resin has a tubular shape capable of collectively including the pair of electric wires 32, and a pair of electric wire insertion holes 41 are formed in an end portion of the holder 40 on the base end side of the electric wires 32. The pair of electric wires 32 are respectively inserted into the pair of electric wire insertion holes 41 of the holder 40. Accordingly, a relative positional relationship between the pair of electric wires 32 is maintained in an appropriate state.

The bellows boot 50 is made of rubber and has a tubular shape capable of collectively including the pair of electric wires 32. The bellows boot 50 is flexibly deformable according to a wiring direction of the pair of electric wires 32 inserted into the bellows boot 50. An attachment portion 51 is provided at the end portion of the bellows boot 50 on the tip end side (terminal 31 side) of the electric wire 32. The attachment portion 51 has a semi-cylindrical shape to collectively close the pair of front and rear opening portions 25 of the housing 20.

In the holder 40 and the bellows boot 50 into which the pair of electric wires 32 of the pair of front and rear terminal-equipped electric wires 30 are inserted, the end portion of the holder 40 on the tip end side of the electric wire 32 and the end portion of the bellows boot 50 on the base end side of the electric wire 32 are airtightly connected to each other (see FIG. 1). Accordingly, by inserting the electric wires 32 of the pair of terminal-equipped electric wires 30 into the holder 40 and the bellows boot 50, it is possible to achieve waterproofing, insulation, or the like of the terminal-equipped electric wires 30.

Each of the terminals 31 of the pair of front and rear terminal-equipped electric wires 30 in a state where the holder 40 and the bellows boot 50 connected to each other are inserted is fastened and fixed to the base end surface of the terminal 10 accommodated in the terminal accommodation hole 23 on the right side and the other end portion 72 of the plate member 70 overlapping the seat surface of the nut 61 by using the bolt 63 in a direction in which the protruding strip portion 34 protrudes toward the front side (see FIGS. 2 and 3). Specifically, the terminal 31 on the front side of the pair of front and rear terminals 31 is placed to overlap the base end surface of the terminal 10 accommodated in the terminal accommodation hole 23 on the right side via the opening portion 25 on the front side, and is fastened and fixed to the base end surface of the terminal 10 by screwing the bolt 63 inserted into the bolt insertion hole 33 of the terminal 31 into the female screw hole 11 of the terminal 10. The terminal 31 on rear side of the pair of front and rear terminals 31 is placed to overlap the other end portion 72 of the plate member 70 overlapping the seat surface of the nut 61 via the opening portion 25 on the rear side, and is fastened and fixed to the other end portion 72 (that is, the nut 61) of the plate member 70 by screwing the bolt 63 inserted into the bolt insertion hole 33 of the terminal 31 and the bolt insertion hole 73 of the other end portion 72 of the plate member 70 in this order into the female screw hole of the nut 61.

Accordingly, in order to fasten and fix the pair of front and rear terminals 31, when each of the pair of front and rear terminals 31 is placed on the base end surface of the terminal 10 accommodated in the terminal accommodation hole 23 on the right side or the other end portion 72 of the plate member 70, as illustrated in FIG. 7, the terminal 31 is disposed on the seat surface 26 such that the protruding strip portion 34 of the terminal 31 engages with any one of the plurality of engaging grooves 27a provided in the seat surface 26 of the corresponding opening portion 25. In other words, as illustrated in FIG. 8, the extending direction of the terminal 31 from the fastening axis O of the terminal 31 (that is, the extending direction of the electric wire 32 of the terminal-equipped electric wire 30) can be adjusted by selecting the engaging groove 27a to be engaged with the protruding strip portion 34 of the terminal 31 from the plurality of engaging grooves 27a. Accordingly, when the position of the terminal 31 in the circumferential direction of the fastening axis O of the terminal 31 is adjusted according to a desired wiring direction, the electric wire 32 can be extended according to the wiring direction without being excessively curved. At this time, since the bellows boot 50 is deformable according to the wiring direction of the electric wire 32, the bellows boot 50 does not hinder the wiring of the electric wire 32.

As can be understood from FIGS. 2 and 8, the opening portion 25 has an opening width through which the terminal 31 can be inserted into and out of the tubular portion 22 even when any of the plurality of engaging grooves 27a provided in the seat surface 26 engages with the protruding strip portion 34 of the terminal 31 (that is, regardless of the extending direction of the terminal-equipped electric wire 30 from the fastening axis O of the terminal 31). Therefore, the terminal 31 of the terminal-equipped electric wire 30 and the opening edge of the opening portion 25 do not interfere with each other regardless of the direction in which the electric wire 32 of the terminal-equipped electric wire 30 extends.

As described above, after the fastening and fixing of the terminals 31 of the pair of front and rear terminal-equipped electric wires 30 is completed, as illustrated in FIG. 1, the attachment portion 51 of the bellows boot 50 is attached to the tubular portion 22 of the housing 20 to collectively close the pair of front and rear opening portions 25 of the tubular portion 22. As illustrated in FIG. 1, a lid-shaped member 28 (see FIG. 2) is assembled to the tubular portion 22 of the housing 20 to partially close a rear end opening of the tubular portion 22.

Thus, the assembly of the connector 1 is completed. The housing 20 of the assembled connector 1 is fixed to a vehicle body or the like of an automobile using a plurality of attachment portions 29 (see FIGS. 1 and 2) provided at a plurality of locations on the outer periphery of the body portion 21. Further, the holder 40 that collectively covers the electric wires 32 of the pair of front and rear terminal-equipped electric wires 30 is also fixed to the vehicle body or the like of the automobile using an attachment portion 42 (see FIGS. 1 and 2) provided on the holder 40. Accordingly, it is possible to prevent the occurrence of problems such as vibration of the holder 40 and the bellows boot 50 connected to the holder 40 when the connector 1 is used.

### Operations and Effects

As described above, according to the connector 1 of the present embodiment, the terminal-equipped electric wire 30 includes an engaging portion (protruding strip portion 34) that engages with the housing 20, and the position of the second terminal 31 in the circumferential direction of the fastening axis O of the second terminal (terminal 31) can be adjusted by adjusting an engaging position between the engaging portion 34 and the housing 20. When the position of the second terminal 31 in the circumferential direction of the fastening axis O is adjusted according to a desired wiring direction, the electric wire 32 can be extended according to the wiring direction without being excessively curved. Further, the housing 20 includes the opening portion 25 having an opening width through which the terminal-equipped electric wire 30 can be inserted into and out of the housing 20 regardless of the position of the second terminal 31 in the circumferential direction. Accordingly, the terminal-equipped electric wire 30 and the housing 20 do not interfere with each other regardless of the direction in which the electric wire 32 extends. Accordingly, the connector 1 according to the present embodiment can cope with various wiring directions while using the common housing 20.

Further, according to the connector 1 of the above embodiment, it is possible to provide the connector 1 capable of coping with various wiring directions according to the number, arrangement, or the like of a plurality of engaged portions (engaging grooves 27a) provided in the housing 20.

Further, according to the connector 1 of the above embodiment, since the plurality of engaged portions 27a are arranged at the opening edge of the opening portion 25 of the housing 20, a space for providing the engaged portions inside the housing 20 or the like is not required, and thus it is possible to avoid an increase in size of the housing 20 due to the provision of the engaged portions 27a.

Further, according to the connector 1 of the above embodiment, waterproofing, insulation, or the like of the terminal-equipped electric wire 30 can be achieved by inserting the terminal-equipped electric wire 30 into a tubular body (bellows boot 50). Since the tubular body 50 is deformable according to the wiring direction of the terminal-equipped electric wire 30, the tubular body 50 does not hinder the wiring of the electric wire 32.

Further, according to the connector 1 of the above embodiment, by attaching the attachment portion 42 of the tubular body (holder 40) to the peripheral member, it is possible to prevent the occurrence of problems such as vibration of the tubular body 40 during use of the connector 1.

### Other Embodiments

The present disclosure is not limited to the above embodiment, and various modifications can be adopted within the scope of the present disclosure. For example, the present disclosure is not limited to the above embodiment, and modifications, improvements, or the like can be appropriately made. In addition, materials, shapes, sizes, numbers, arrangement positions, and the like of the components in the above embodiment are freely selected and are not limited as long as the present disclosure can be implemented.

Here, features of the embodiment of the connector 1 according to the present disclosure described above are briefly summarized and listed in following [1] to [5].

### First Aspect

A connector (1) includes:

a first terminal (10) configured to connect to a counterpart terminal;

a housing (20) configured to accommodate the first terminal (10); and

a terminal-equipped electric wire (30) including: a second terminal (31) configured to be fastened to a predetermined portion inside the housing (20) and electrically connected to the first terminal (10); an electric wire (32) extending from the second terminal (31); and an engaging portion (34) engaged with the housing (20), in which

a position of the second terminal (31) in a circumferential direction of a fastening axis (O) of the second terminal (31) is adjustable by adjusting an engaging position between the engaging portion (34) and the housing (20), and

the housing (20) includes an opening portion (25) having an opening width through which the terminal-equipped electric wire (30) is insertable into and out of the housing (20) regardless of the position of the second terminal (31) in the circumferential direction.

According to the connector having the configuration of the first aspect, the terminal-equipped electric wire includes the engaging portion that engages with the housing, and the position of the second terminal in the circumferential direction of the fastening axis of the second terminal can be adjusted by adjusting the engaging position between the engaging portion and the housing. Further, the opening portion of the housing has an opening width through which the terminal-equipped electric wire can be inserted into and out of the housing regardless of the position of the second terminal. Accordingly, when the position of the second terminal in the circumferential direction of the fastening axis is adjusted according to the wiring direction of the electric wire, the electric wire can be extended from the housing to cope with the wiring direction. Accordingly, the connector having this configuration can cope with various wiring directions while using a common housing.

### Second Aspect

In the connector (1) according to the first aspect,

the housing (20) includes a plurality of engaged portions (27a) engageable with the engaging portion (34), and

the position of the second terminal (31) of the terminal-equipped electric wire (30) in the circumferential direction is adjustable by engaging any of the plurality of engaged portions (27a) with the engaging portion (34).

According to the connector having the configuration of the second aspect, it is possible to provide a connector capable of coping with various wiring directions according to the number, arrangement, or the like of the plurality of engaged portions provided in the housing.

### Third Aspect

In the connector (1) according to the second aspect,

the plurality of engaged portions (27a) are arranged side by side in the circumferential direction at an opening edge of the opening portion (25).

According to the connector having the configuration of the third aspect, since the plurality of engaged portions are arranged at the opening edge of the opening portion of the housing, a space for providing the engaged portions inside the housing or the like is not required, and thus it is possible to avoid an increase in size of the housing due to the provision of the engaged portions.

### Fourth Aspect

The connector (1) according to the first aspect further includes:

a tubular body (50) having a tubular shape into which the terminal-equipped electric wire (30) is inserted and deformable according to a wiring direction of the terminal-equipped electric wire (30).

According to the connector having the configuration of the fourth aspect, waterproofing, insulation, or the like of the terminal-equipped electric wire can be achieved by inserting the terminal-equipped electric wire into the tubular body. Since the tubular body is deformable according to the wiring direction of the terminal-equipped electric wire, the tubular body does not hinder the wiring of the electric wire.

### Fifth Aspect

The connector (1) according to the fourth aspect further includes:

an attachment portion (42) for attaching the tubular body (40) to a peripheral member.

According to the connector having the configuration of the fifth aspect, by attaching the attachment portion of the tubular body to the peripheral member, it is possible to prevent the occurrence of problems such as vibration of the tubular body during use of the connector.

What is claimed is:

1. A connector comprising:
a first terminal configured to connect to a counterpart terminal;
a housing configured to accommodate the first terminal; and
a terminal-equipped electric wire including: a second terminal configured to be fastened to a predetermined portion inside the housing and electrically connected to the first terminal; an electric wire extending from the second terminal; and an engaging portion engaged with the housing,
wherein a position of the second terminal in a circumferential direction of a fastening axis of the second terminal is adjustable by adjusting an engaging position between the engaging portion and the housing, and
wherein the housing includes an opening portion having an opening width through which the terminal-equipped electric wire is insertable into and out of the housing regardless of the position of the second terminal in the circumferential direction.

2. The connector according to claim 1,
wherein the housing includes a plurality of engaged portions engageable with the engaging portion, and
wherein the position of the second terminal of the terminal-equipped electric wire in the circumferential direction is adjustable by engaging any of the plurality of engaged portions with the engaging portion.

3. The connector according to claim 2,
wherein the plurality of engaged portions are arranged side by side in the circumferential direction at an opening edge of the opening portion.

4. The connector according to claim 1, further comprising:
a tubular body having a tubular shape into which the terminal-equipped electric wire is inserted and deformable according to a wiring direction of the terminal-equipped electric wire.

5. The connector according to claim 4, further comprising:
an attachment portion for attaching the tubular body to a peripheral member.
